(19) United States
(12) Patent Application Publication
(10) Pub. No.: US 2025/0110604 A1
(43) Pub. Date: Apr. 3, 2025

(54) INTERACTIVE GRAPHICAL USER INTERFACE FOR ASTROCARTOGRAPHY

(71) Applicant: ASTROCARTO LLC, Houston, TX (US)

(72) Inventor: Alexandra CLARK, Austin, TX (US)

(21) Appl. No.: 18/480,328

(22) Filed: Oct. 3, 2023

(51) Int. Cl. G06F 3/04815; G06F 3/04842

(52) U.S. Cl. CPC G06F 3/04815; G06F 3/04842

(57) ABSTRACT

Devices, systems and methods for generating a graphical user interface for interacting with astrocartographical data are described. First information comprising a birth date, a birth time, and a birth location may be received from a user. Second information comprising multiple celestial body positions may be retrieved, and the device or another device may determine one or more celestial body positions from the multiple celestial body positions relative to Earth corresponding to the first information. A device may generate a three-dimensional trajectory ring corresponding to rising and setting boundaries and a three-dimensional meridian ring corresponding to the one or more celestial body positions. A device may project the trajectory ring and the meridian ring onto a two-dimensional surface representative of a surface of the Earth. Additional information associated with the celestial bodies may be displayed on the two-dimensional surface or elsewhere on the graphical user interface.

### TECHNICAL FIELD

This document relates generally to astrocartography, and more specifically, to methods, systems, and devices for implementing an interactive graphical user interface to process and display astrocartographical data.

### BACKGROUND

Astrocartography is a method of locational astrology, by which specific geographic locations are associated with expected differences in personal life circumstances. Specifically, astrocartography is a location astrology that focuses on location on the earth where planets were angular at the event of a person's birth. An “angular” planet is one that is conjunct with one of four angles: Ascendant, Descendant, Medium Coeli, or Imum Coeli. The locations associated with these angles at birth are believed to influence key areas and moments in a person's lifetime. The angles are derived from the horizon (Ascendant and Descendant) and the meridian (Midheaven and Imum Coeli) at that the event of a person's birth. Typically, astrocartographical information is determined by astrologers.

### BRIEF DESCRIPTION OF THE DRAWINGS

FIG. 1 shows a block diagram of an example system for interacting with astrocartographical data using a graphical user interface, in accordance with embodiments of the disclosed technology.

FIG. 2A shows an example of lines representing celestial body paths on a three-dimensional projection of the Earth, in accordance with embodiments of the disclosed technology.

FIG. 2B shows an example of how lines representing celestial body paths on a three-dimensional projection of the Earth are generated, in accordance with embodiments of the disclosed technology.

FIG. 3 shows examples of the planetary symbols available through the graphical user interface, in accordance with embodiments of the disclosed technology.

FIG. 4 shows an example of overlaying the lines representing planetary paths and the planetary symbols on a two-dimensional projection of the Earth, in accordance with embodiments of the disclosed technology.

FIG. 5 shows an example of a flow diagram that enables interaction, through the graphical user interface, with astrocartographical data, in accordance with embodiments of the disclosed technology.

FIG. 6 is a block diagram illustrating components of at least a portion of an exemplary blockchain system, in accordance with one or more embodiments of this disclosure.

FIG. 7 is a block diagram illustrating an example machine learning (ML) system, in accordance with one or more embodiments of this disclosure.

FIG. 8 is a block diagram illustrating an example computer system, in accordance with one or more embodiments of this disclosure.

### DETAILED DESCRIPTION

Embodiments of the disclosed technology provide users simple and easy to access to astrocartographical information. Traditionally, astrological information is provided by astrologers, who provide distinct manually created information customized to a particular person. Alternatively, people interested in astrological recommendations or information without access to an astrologer conventionally access general information that is not unique to them. As astrocartography is a location astrology that focuses on location on the earth where planets were angular at the event of a specific person's birth, customized information is important to understanding how astrological celestial bodies will influence geographical regions and events in that specific person's lifetime.

Introduced here are methods, devices, and systems for providing customized astrocartographical information and related astrological information to a user. Specifically, the methods, devices, and systems herein allow a user to obtain an astrocartographical map that is customized to their personal birth time, year, and location. Based on this input information, the positions of one or more celestial bodies with respect to the Earth is determined, as well two three-dimensional rings associated with each celestial body: a trajectory ring and a meridian ring. The three-dimensional rings may be associated with the light reflected or emitted from the celestial body onto Earth. The two three-dimensional rings may be projected onto a two-dimensional surface representative of the surface of the Earth as lines. This two-dimensional surface and lines may be presented to the user on a graphical user interface, where the user can glean customized astrological information, as well as tailored recommendations based on the particular celestial bodies and their respective trajectory and meridian rings.

Methods, devices, and systems herein present customized astrological information to a user on a graphical user interface. The astrological information may include geographical regions that are associated with the user's personal birth information. For example, the astrological information may include lines associated with celestial bodies such as planets. In some cases, the astrological information may include astrological suggestions based on the user's current location (for example, obtained by a global positioning system). In other cases, the astrological information may include astrological suggestions based on a location selected by a user on the graphical user interface. The suggestions may include travel activities, lodging recommendations, dining recommendations, career recommendations, relationship recommendations, or other general activities. In some cases, a user may select a celestial body or a line representative of the celestial body on a graphical user interface to see a geographical area of influence of that celestial body.

In addition to the above, the methods, devices, and systems herein allow for a user to further customize and tailor the custom astrological information they receive. The inventor has appreciated that there is a large volume of astrological information that may or may not be relevant to a particular person's needs. For example, astrological information may relate to, among other categories, relationships, travel, career, personality strengths, and personality weaknesses. For a particular person, some or all of this information may be relevant to them. Accordingly, in some methods herein, a user may select one or more filter parameters so that they receive astrological information, including suggestions, on a graphical user interface in categories within their filter parameters. In this manner, a user may receive the most relevant customized information to their needs.

The inventor has also appreciated that generative artificial intelligence (AI) may be employed to generate astrological information, including suggestions, based on one or more inputs from the user (such as birth information), positions of celestial bodies, categories of suggestions, or other input as well as a request from the user. For example, a user may request travel suggestions after providing input such as their personal birth information. Travel suggestions may be generated by one or more generative machine learning models that are trained to generate travel suggestions. The one or more generative machine learning models may be training on input training data including birth date, birth time, birth location, celestial body positions, and/or exemplary travel suggestion outputs. The travel suggestions output the one or more generative machine learning models may include newly generated portion of content that shares properties with the input training data, and therefore extends the input training data. The one or more generative machine learning models may extend to other suggestions other than travel suggestions, as the present disclosure is not so limited. In some embodiments, the generative machine learning model may implement natural language processing. In some embodiments, a method may include retrieving social medial information from one or more social media feeds, and using a machine learning algorithm to extract astrological aspects related to the celestial body positions from the social medial information. For example, information related to relationships or events may be extracted from the social media information according to the positions of celestial bodies for the user.

Given the specific inputs of (i) birth date, (ii) birth time, and (iii) birth place, a device according to embodiments herein can:
Determine the positions of celestial bodies at the birth date and birth time of a user;
Determine a trajectory ring of the celestial bodies corresponding to a rising and setting boundary of the celestial body on the surface of the Earth;
Determine a meridian ring of the celestial bodies corresponding to the longitudinal position of the celestial body on the surface of the Earth;
Project the three-dimensional positions of the celestial bodies, the trajectory ring, and the meridian ring onto a two-dimensional surface representative of the surface of the Earth;
Display the projected positions, trajectory rings, meridian rings, and a two-dimensional surface representative of the Earth on a graphical user interface; and
Display relevant astrological information to a user on the graphical user interface corresponding to the positions of the celestial bodies, the meridian rings, and the trajectory rings.

In some embodiments, a method of projecting astrocartographical information onto a two-dimensional map surface may include:
Receiving a person's birth date, time, and location from a user at graphical user interface;
Determining a Local Sidereal Time (LST) based on the birth date, time, and location, where the LST is the angle between the birth location's meridian and the vernal equinox expressed in time units;
Determining the positions of the celestial bodies in the local sky based on the determined LST;
Determining the birth location latitude, and the declination of the ecliptic, the horizon based on the LST and the position of the celestial bodies;
Determining Ascendant and Descendant angles based on the horizon;
Determining the Midheaven and Imum Coeli based on an intersection where a meridian of the birthplace intersects the ecliptic;
Determining locations where the celestial bodies are angular based on the positions of the celestial bodies and the birth location latitude; and
Projecting the locations where the celestial bodies are angular onto two-dimensional representation of the Earth.

Methods of exemplary embodiments herein may be implemented on one or more computing devices, for example, as computer-readable instructions executed by a processor of the computing device. A graphical user interface may be generated on a display of a computing device. The computing device may be a mobile device, such as a smart phone, tablet, laptop, etc. In other embodiments, any computing device may be employed. In some embodiments, methods described herein may be performed on a single computing device. In other embodiments, methods described herein may entail communication between multiple computing devices. For example, a user device may communicate with a remote device such as a server of a server system. In some embodiments, a computing device may have an application programming interface (API) through which the user or another device may request and obtain information. In some embodiments, the method may be performed as a part of a software application executing on a computing device.

Embodiments may be described in the context of computer-executable instructions for the purpose of illustration. However, aspects of the approach could be implemented via hardware or firmware instead of, or in addition to, software.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, the term “based on” is intended to mean “based at least in part on.”

When used in reference to a list of multiple items, the word “or” is intended to cover all of the following interpretations: any of the items in the list, all of the items in the list, and any combination of items in the list.

Section headings are used in the present document to improve readability of the description and do not in any way limit the discussion or the embodiments to the respective sections only.

### 1 Introduction and Overview

Embodiments of the disclosed technology provide a solution for interacting with astrocartographical data using a graphical user interface. Particularly, as noted above, embodiments of the disclosed technology provide customized, filterable astrocartographical information based on inputs unique to each user.

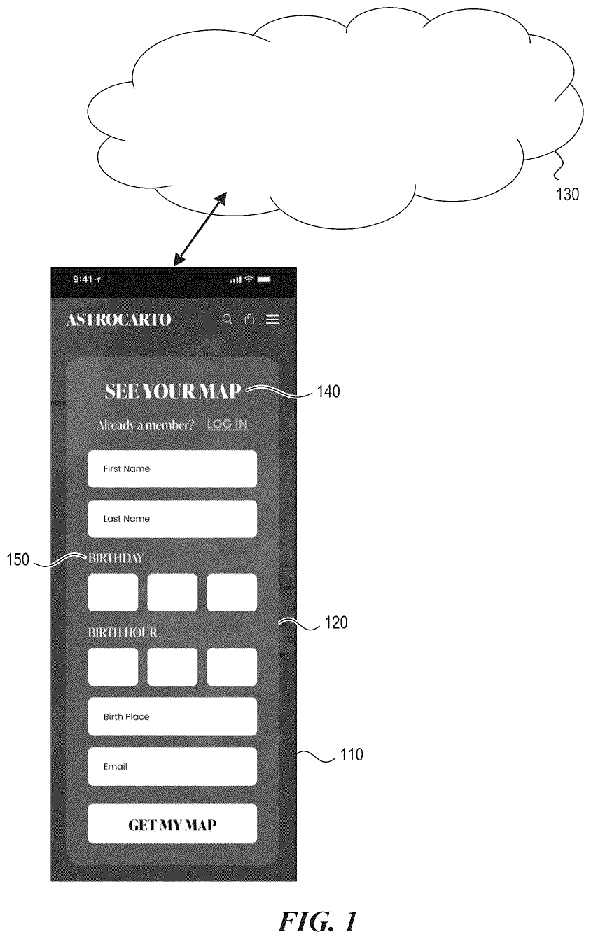

FIG. 1 shows a block diagram of an example system that includes a user device 110, which is running a mobile application 120 that enables interacting with astrocartographical data through a graphical user interface. The user device 110 (e.g., personal computer, smartphone, tablet, smart watch) is configured to communicate with a remote server 130 (e.g., remote data system, cloud computing system, software-as-a-service system) using a communication link and, for example, either a cellular network access point or a Wi-Fi access point. The communication link may include one or more wired or wireless links.

In the example shown in FIG. 1, the mobile application 120 enables a user to obtain a personalized map based on user input. The mobile application 120 generates a graphical user interface 140. The graphical user interface is configured to receive user input through multiple fields 150. In the example of FIG. 1, the multiple fields 150 allow a user to input their birth date, birth hour, and birthplace. Optionally, as shown in FIG. 1, the user may be able to input secondary information such as their name and email address. In some circumstances, the secondary information may be employed by the mobile application 120 to create an account for the user, such that their information and their personalized map may be saved to the mobile application 120 or a remote server 130 in communication with the mobile application. In some embodiments, the mobile application 120 may be an application programming interface (API), such that the birth date, birth time, and birth location are received from a user using the API. In some embodiments, the mobile application 120 may communicate the received information to the remote server 130. For example, the user's birth date, birth time, and birth place may be transmitted to the remote server 130 for further processing as discussed further below.

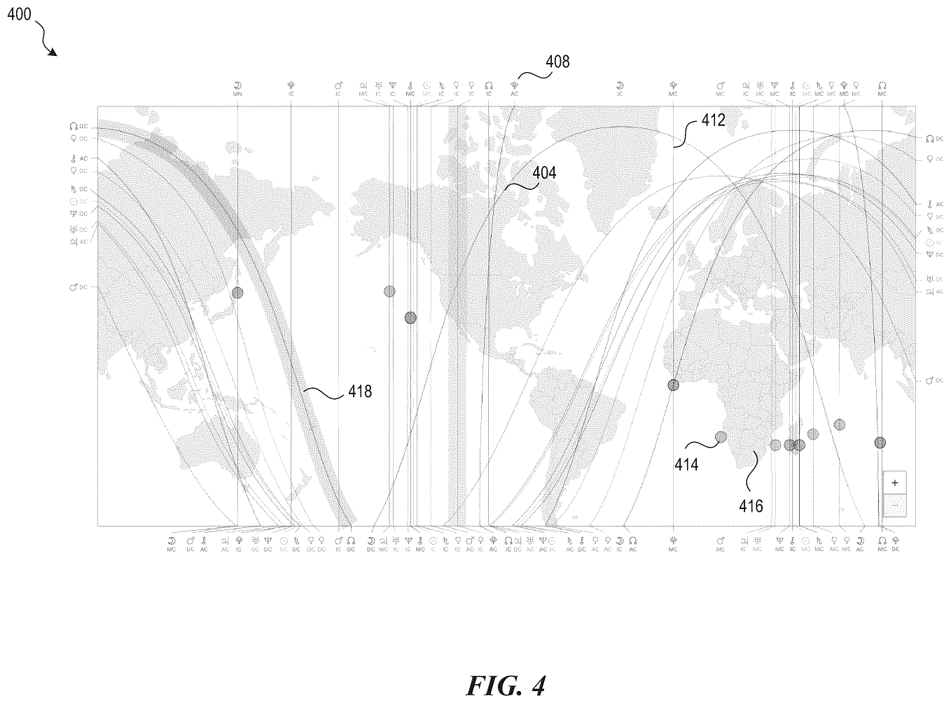

The information received by the mobile application 120 may be used to generate a personalized astrocartographical map. That is, based on the input of birth date, birth hour, and birth place at the multiple fields 150, a user may obtain a personalized map as well as other information relevant to the map and the user. An exemplary output of the mobile application 120 is shown in FIG. 4. According to some embodiments, processing of the user input information and celestial body information may be performed on the user device 110, on the remote server 130, or on a combination of the user device and the remote server 130.

In some embodiments, the mobile application 120 may be configured to receive additional input from the user to control the graphical user interface 140 or to provide additional relevant information to a user. For example, the mobile application 120 may receive input to move a map, zoom in or zoom out, select an item on the map, or select a location on the map. Based on such user input, the information displayed by the graphical user interface 140 may change. For example, based on a selection of an astrocartographical line, the graphical user interface may display an area of influence of that line. As another example, the graphical user interface may display suggestions or other information based on the selection. In the case of a selection of a location on the map, information related to one or more celestial bodies may be displayed on the graphical user interface based on the selected location, which may include suggestions related to activities, career, and relationships relevant to that location. In some embodiments, the mobile application 120 may obtain information from one or more sensors of the user device 110. For example, the user device 110 may include a global navigational satellite system (GNSS) chip configured to obtain a present location of the user device. The mobile application 120 may obtain the present location of the user device 110 and use the present location to display relevant information regarding one or more celestial bodies to the user on the graphical user interface 140. In some embodiments, the information displayed on the graphical user interface 140 may obtained from the remote server 130. In some embodiments, the mobile application 120 may obtain information from another remote server in addition to the remote server 130. For example, the mobile application 120 may obtain weather information from a weather service and display the weather information on the graphical user interface 140 in combination with personalized astrocartographical information.

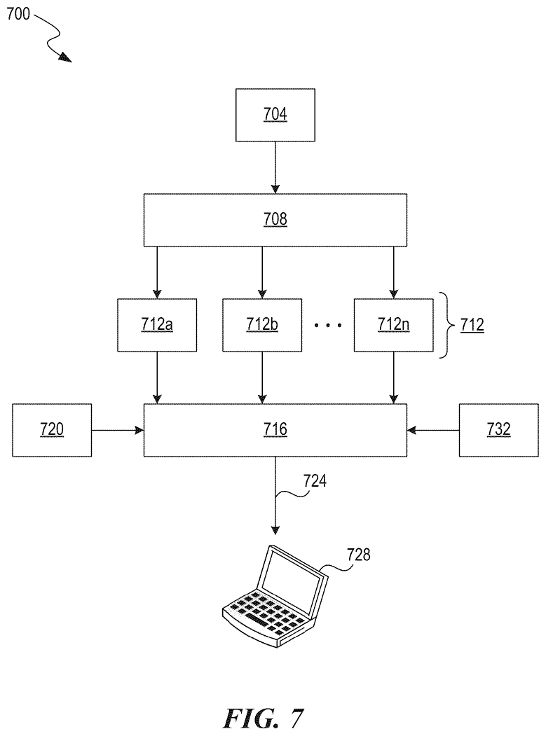

In some embodiments, the mobile application 120 or the remote server 130 may implement one or more generative machine learning modules to obtain information to display to the user on the graphical user interface 140. The machine learning modules may be configured to generate information based on input information as well as information regarding one or more celestial bodies. The one or more generative machine learning modules may be trained to generate information in response to input training data including exemplary input information and output information. The generative machine learning modules may generate information including a newly generated portion of content that shares properties with the input training data and therefore extends the training data. An example of a generative machine learning module is discussed further with reference to FIG. 7.

2 Examples of Interacting with Astrocartographical Data

As noted above, astrocartographical information at a person's birth may influence their later life in different ways at different locations around the Earth. That is, the locations and trajectories of certain celestial bodies with respect to the Earth's surface may provide geographical areas of influence that may affect a person's career, relationships, and life in a way unique to them. The areas of influence may two dimensional areas on the sphere of the Earth. Typically, discovering these areas of influence is difficult to do in a customized manner, as the celestial bodies are constantly moving with respect to Earth, and for each birth date, time, and location the areas of influence and their corresponding influence may be different. Accordingly, devices and methods herein provide a user a customized visualization of the areas of influence based on their unique user input. Exemplary processes for generating such a visualization are discussed further below.

### 2.1 Planetary Lines and Symbols

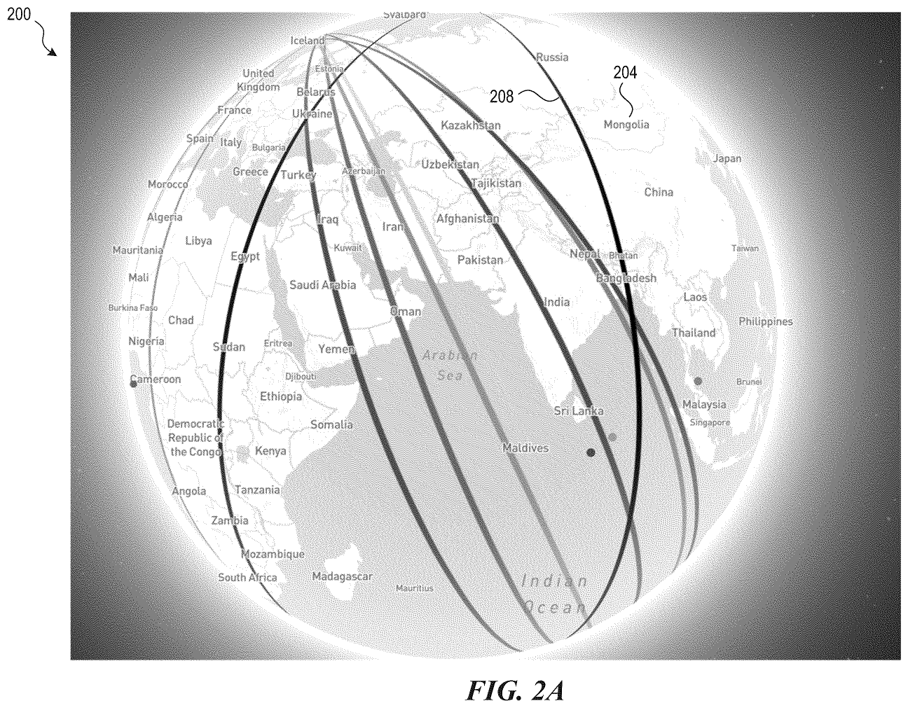

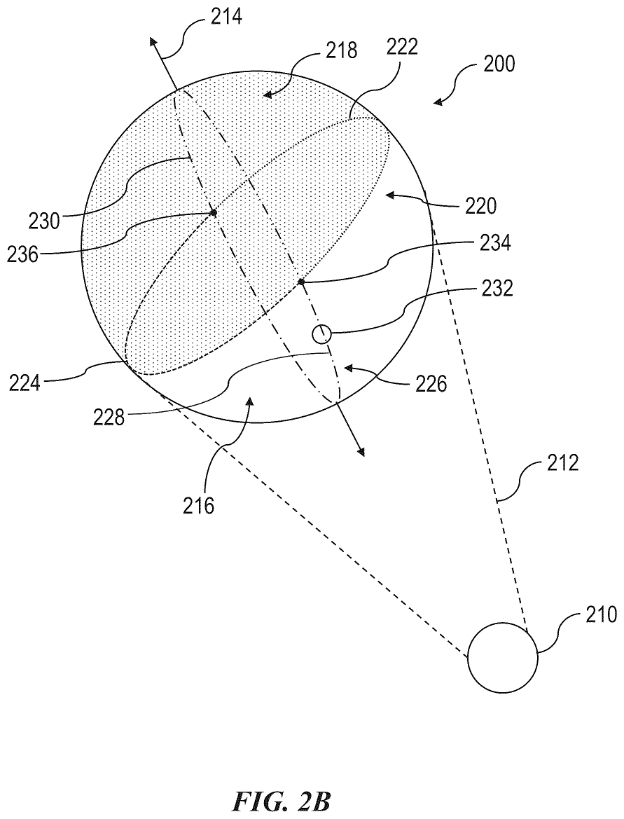

FIG. 2A shows an example of rings representing celestial body rings 208 on a three-dimensional projection of the Earth 200, in accordance with embodiments of the disclosed technology. As shown in in FIG. 2A, various celestial bodies have paths overlaying the spherical surface 204 of the Earth. Each of the rings 208 represents a particular influence of a celestial body on that particular area of the Earth. In some embodiments, the area of influence of a celestial body may be approximately 700 miles wide, centered on each ring. For example, an area of influence of a particular ring may be 350 miles East and 350 miles West for a north-south running ring. Due to the rotation of the Earth and the different movements of the celestial bodies moving through space relative to the Earth, each celestial body corresponds to different respective rings 208 on the surface 204 of the Earth. In some cases, the rings may be representative of different aspects of the position and movements of the celestial bodies. For example, as will be discussed further with reference to FIG. 2B, the rings may generally be representative of locations on the surface 204 of the Earth where a celestial body is “angular” or has a greater influence on a person. These locations may be employed to provide recommendations for a user at the various locations. The rings 208 of FIG. 2A circumscribe the sphere of the Earth.

Celestial bodies may include, but are not limited to, planets in the solar system, asteroids, moons, the sun, stars, and orbital nodes. Celestial bodies represented in a graphical user interface may include, but are not limited to, the sun, the moon, Mercury, Venus, Mars, Jupiter, Saturn, Uranus, Neptune, Pluto, Chiron, Ceres, Eris, and Vesta.

The visualization shown in FIG. 2A is a three-dimensional visualization of the Earth and rings 208 representing various celestial body positions and trajectories. However, the inventor has appreciated that it may be desirable to show a two-dimensional projection of the same information on a graphical user interface of a new device. Accordingly, in some embodiments, the positions of celestial bodies with respect to user input information (e.g., birth date, time, and place) may be employed to generate a two-dimensional visualization with lines representing the rings of the celestial bodies on the sphere of the Earth. An exemplary process of converting the three-dimensional rings to lines is discussed further with reference to FIG. 2B.

FIG. 2B shows an example of how lines representing celestial body paths on a three-dimensional projection of the Earth 200 are generated, in accordance with embodiments of the disclosed technology. As shown in FIG. 2B, a celestial body 210 is in a particular position in space relative to the Earth 200 at a particular time and date (not to scale). For example, the position in space shown in FIG. 2B may represent a position of the celestial body 210 at a user's birth date and time. The celestial body 210 emits light 212 that is incident on the surface of the Earth. The light 212 may be emitted by the celestial body itself, or may reflect light from another celestial body such as the sun. The Earth 200 rotates about an axis 214. As the Earth rotates, the light 212 from the celestial body falls on the Earth in different locations. As shown in FIG. 2B, an illuminated portion 216 of the Earth is illuminated by the light 212 from the celestial body 210, and the unilluminated portion 218 of the Earth is not illuminated by the light from the celestial body. The junction between the illuminated portion 216 and the unilluminated portion 218 is a trajectory ring 220, which represents a rising and setting trajectory of the celestial body 210 as the Earth rotates about its axis 214. The trajectory ring 220 represents the Ascendant and Descendant in astrocartography. A meridian ring 226 is also shown, which intersects the trajectory ring at the highest and lowest horizon points. The meridian ring 226 is a north-south ring, and corresponds to the particular longitude where the trajectory ring is highest and lowest. The meridian ring 226 represents the Medium Coeli and Imum Coeli in astrocartography. A circle 232 represents where the celestial body 210 is directly overhead. This circle represents the Zenith in astrocartography.

As shown in FIG. 2B, a first intersection 234 and a second intersection 236 between the meridian ring 226 and the trajectory ring 220 splits the trajectory ring into two sections. A first section 222 represents the Descendant, as the light from the celestial body 210 is setting as the Earth 200 rotates. The first section 222 extends from the first intersection 234 to the second intersection 236. A second section 224 represents the Ascendant, as the light form the celestial body 210 is rising at the Earth 200 rotates. The second section 224 extends from the second intersection 236 to the first intersection 234. When projected onto a two-dimensional surface of the Earth 200, the first section 222 and the second section 224 may be a continuous curved line. The first section 222 and second section 224 may be denoted with labels, with each section falling on either side of lines representing the meridian ring 226. In some embodiments, the curved line representing the first section 222 and the second section 224 may be sinusoidal when projected onto a two-dimensional surface.

The meridian ring 226 may be represented on a two-dimensional projection as two vertical lines, each representing a particular longitude. A third section 228 of the meridian ring 226 including the circle 232 representative of the Zenith is represented as a first vertical line on a two-dimensional projection at a first longitude. This third section extends from the north pole the south pole and represents the Medium Coeli. A fourth section 230 of the meridian ring 226 that does not include the circle 232 is represented as a second vertical line on a two-dimensional projection of the Earth at a second longitude. This fourth section extends from the north pole the south pole and represents the Imum Coeli.

In the manner discussed above, the trajectory ring 220 and the meridian ring 226 for each desired celestial body 210 may be broken into sections and projected onto a two-dimensional representation of the Earth. Accordingly, the information may then be displayed to the user on a two-dimensional map as a part of a user interface, for example, as shown in FIG. 4. The processing of user input and celestial body position information may be performed onboard a user device, in some embodiments. The celestial body information may be received by the user device from a remote server, in some embodiments. In some cases, the celestial body information may be obtained by an application programming interface (API). For example, a user device may obtain celestial body information with a call to the API with an input of a particular date and time (e.g., a user's birth date and time). In other embodiments, user input may be transmitted to a remote server, which may process the user input and information regarding the position of celestial bodies to project trajectory rings and meridian rings onto a two-dimensional surface. In some embodiments, a three-dimensional projection of the Earth 200 may be displayed on a graphical user interface based on user input.

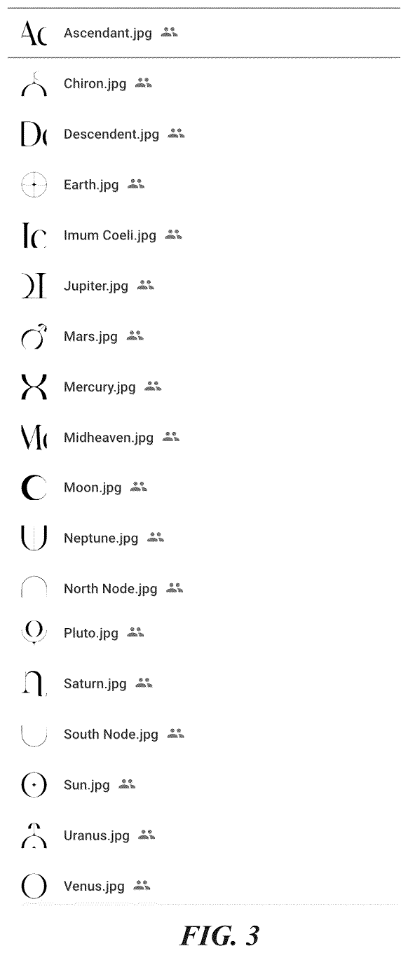

In some embodiments, the process described with reference to FIG. 2B may be repeated for as many celestial bodies as desired. In some cases, twelve celestial bodies may be projected onto a two-dimensional representation of the surface of the Earth. Each of celestial body may be represented by at least one curved line (for the trajectory ring) and two vertical lines (for the meridian ring). The lines may be labeled on the map in the graphical user interface, for example, with labels of the planetary symbols shown in FIG. 3. In some embodiments, a user may filter one or more celestial bodies to display on a graphical user interface. In this manner, a user may select and see lines on a two-dimensional map for the selected celestial bodies.

FIG. 4 shows an example of overlaying the lines representing planetary paths and the planetary symbols on a two-dimensional projection of the Earth 400, in accordance with embodiments of the disclosed technology. As shown in FIG. 4, vertical lines 412 are overlayed on a map surface 416. There are two vertical lines for each celestial body. A circle 414 or other graphical symbol is positioned on one of the vertical lines, representing the Zenith of the celestial body. Curved lines 404 for each celestial body represent the Ascendant and Descendent sections of a trajectory ring for each celestial body. As shown in FIG. 4, labels 408 may be applied to indicate to a user of the graphical user interface what lines belong to what celestial body and what specific aspect of the celestial body. In some embodiments, a user may select a line to see an area of influence 418 of that line on the map surface 416. In some embodiments, this may be an area extending 350 miles in either direction perpendicularly from the line (e.g., for a width of 700 miles).

### 2.2 Characteristics of Celestial Bodies

Embodiments of the disclosed technology enable a user to explore the different effects of each of the celestial bodies with respect to geographical locations on the two-dimensional map, for example, as shown in FIG. 4. In some embodiments, a mobile application on a user device may obtain information related to the celestial bodies and their areas of geographic influence, the location of the user, and/or a selected location from the user. For example, a user may select a line on two-dimensional surface of the map and may receive information regarding activities or advice specific to the area of influence of that line. As another example, a user may input his or her current location and receive suggestions based on the nearby area of influence of lines. The suggestions may include activities to do, advice for aspects of life to focus on, etc. As still another example, a user may provide a selected location on the map. The information displayed may then receive suggestions based on the nearby area of influence of lines in the selected location. The information may be obtained by a user device from a remote server. In some embodiments, the suggestions may be obtained from a generative machine learning model, an example of which is discussed further with reference to FIG. 7.

In some embodiments, after generating a map, a mobile application may provide the user suggestions for positive geographical areas on the map associated with the one or more celestial bodies displayed through the graphical user interface. For example, the mobile application may provide to the user suggestions for locations to travel, locations to move for career, locations to move for relationships, etc. The suggestions may be obtained by a user device from a remote server. In some embodiments, the suggestions may be obtained from a generative machine learning model, an example of which is discussed further with reference to FIG. 7.

In some embodiments, after generating a map, a mobile application may provide the user weather information displayed through the graphical user interface. In some embodiments, the weather information may be obtained through an application programming interface (API) from a weather service.

In some embodiments, after generating a map, a mobile application may provide the user social media information displayed through the graphical user interface. For example, information from one or more social media feeds may be displayed on the graphical user interface. Social media information tied to specific geographical locations and relationships may be displayed on the map. For example, social information related to specific aspects of celestial bodies may be displayed on the graphical user interface. In some embodiments, a machine learning algorithm may be used to extract aspects related to one or more celestial bodies from social media information. In some embodiments, the social media information may be obtained through an application programming interface (API) from a social media service.

As a large amount of information may be displayed to the user on the graphical user interface, in some embodiments a user may provide filter input to select one or more categories of information or suggestion types. A mobile application may then filter the information displayed based on the filter input received from the user. In this manner, information or suggestions displayed are relevant to the user. As an example, filter input from a user may be received that indicates the user wishes to see travel information. Based on this filter input, information displayed on the graphical user interface may be limited to suggestions for travel, areas of influence relevant to travel, and other travel related information. Other categories may be employed, including relationships and career, among others.

The information described above that may be displayed as a part of a graphical user interface is by example only. With an underlying two-dimensional map, a variety of astrological and other information may be displayed for a user that is relevant to the customized map of celestial bodies.

### 3 Example Embodiments and Implementations

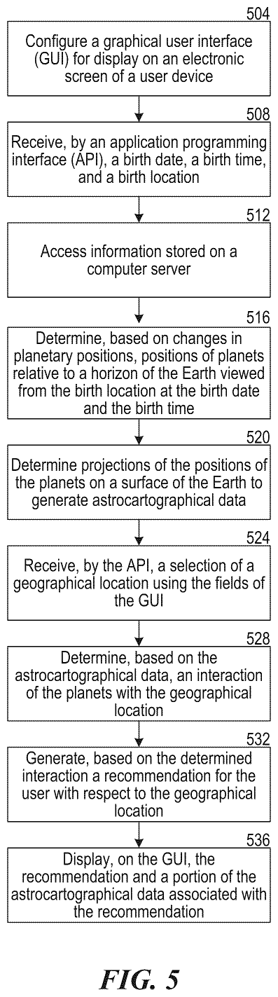

In some embodiments, the flow diagram enabling interaction, through the graphical user interface, with astrocartographical data is shown in FIG. 5.

In act 504, a graphical user interface is configured for display on an electronic screen of a user device. For example, a user may open a mobile application on a user device.

In act 508, a birth date, birth time, and birth location are received by an application programming interface. The birth date, birth time, and birth location may be received in one or more fields displayed on the graphical user interface.

In act 512, information stored on a computer server is accessed. The information may be accessed by the user device. In some embodiments, the information may include one or more positions of one or more celestial bodies with respect to Earth. In some embodiments, the information is a part of a database of positions of celestial bodies with respect to Earth over a multitude of time periods. In some embodiments, the information includes a model to determine a position of a celestial body at a particular time. In some embodiments, the information may be accessed via a network.

In act 516, positions of celestial bodies such as planets are determined relative to a horizon of Earth view from the birth location at the birth date and time. The positions of the celestial bodies may be determined from the information accessed in act 512.

In act 520, projections of the positions of the celestial bodies (e.g., planets) on a two-dimensional surface of the Earth are determined to generate astrocartographical data. The projection process may be like that described with reference to FIGS. 2A-2B, in some embodiments.

In act 524, a selection of a geographical location is received by the API using fields of the graphical user interface. For example, a user may tap on the electronic screen to select one of the projections (e.g., lines) on the graphical user interface. In some cases, the geographical location may be a present location of the user. In other cases, the geographical location may be a selected location on a map.

In act 528, an interaction of the celestial bodies (e.g., planets) and the geographical location is determined based on the astrocartographical data. The interaction may also be determined based on the previously accessed information, in some embodiments. The interaction may include suggestions or other information relevant to the various celestial bodies as discussed herein. In some embodiments, a user selects a location on the map and a summary of the influence of the celestial bodies is displayed in a pop-up window. The summary influence of the planet in the summary is a function of the distance between a specific celestial body line and the location, e.g., closer to the line, the stronger the effect of that celestial body. Strongest effect of a celestial body may be felt when location is within 300 miles of the corresponding celestial body line.

In act 532, based on the determined interaction, a recommendation is generated for a user with respect to the geographical location. For example, a travel recommendation, career recommendation, relationship recommendation, etc. may be recommended.

In act 536, the recommendation and at least a portion of the astrocartographical data is displayed on the graphical user interface. The information may be displayed on a two-dimensional map representative of the surface of the Earth. The information may be displayed as graphical symbols and/or text. The astrocartographical data may be displayed as lines on the map.

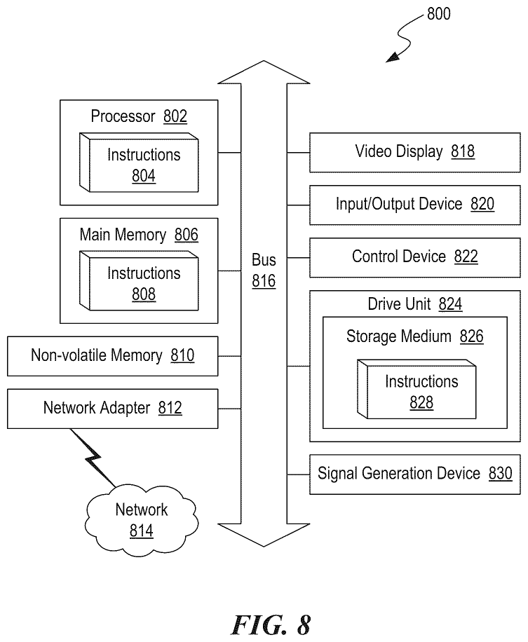

FIG. 5 shows an example of a flow diagram that enables interaction, through the graphical user interface, with astrocartographical data, in accordance with embodiments of the disclosed technology. In some implementations, the process is performed by user device 110 illustrated and described in more detail with reference to FIG. 1. In some implementations, the process is performed by a computer system, e.g., example computer system 800 illustrated and described in more detail with reference to FIG. 8. Particular entities, for example, a mobile application 120 performs some or all of the steps of the process in other implementations. Mobile application 120 is illustrated and described in more detail with reference to FIG. 1. Likewise, implementations can include different and/or additional steps or can perform the steps in different orders.

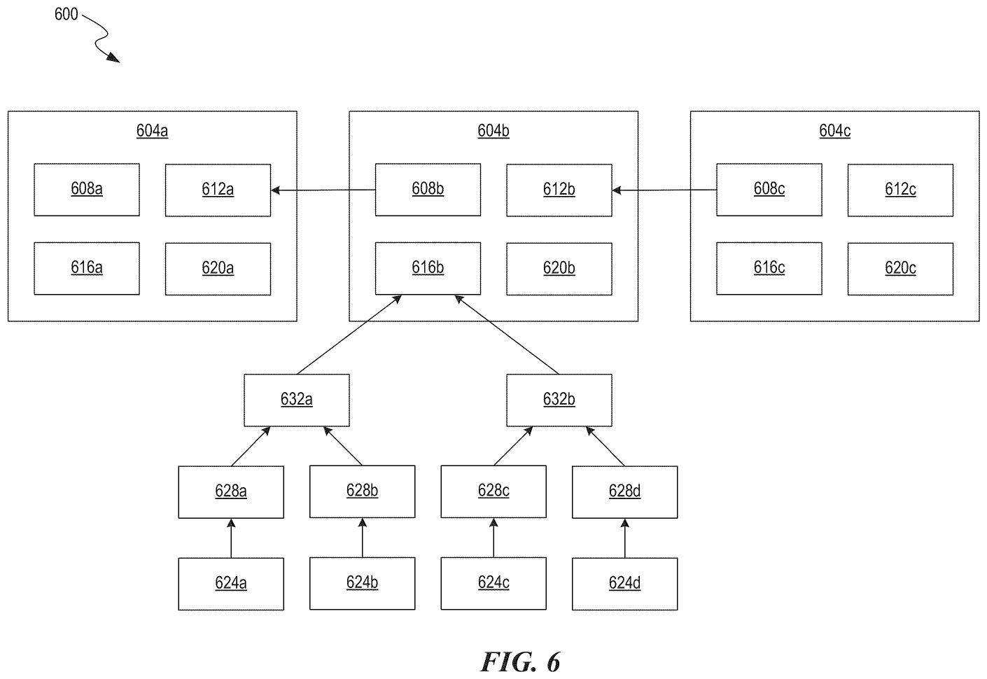

FIG. 6 is a block diagram illustrating components of at least a portion of an exemplary blockchain system 600, in accordance with one or more embodiments of this disclosure. In some embodiments, the functionality discussed herein, including transfer of user and astrological information, may be accomplished through such a blockchain system 600. Blockchain system 600 includes blockchain 604. In embodiments, the blockchain 604 is a distributed ledger of transactions (e.g., a continuously growing list of records, such as records of transactions for digital assets such as cryptocurrency, bitcoin, or electronic cash) that is maintained by a blockchain system 600. For example, the blockchain 604 is stored redundantly at multiple nodes (e.g., computers) of a blockchain network. Each node in the blockchain network can store a complete replica of the entirety of blockchain 604. In some embodiments, the blockchain system 600 implements storage of an identical blockchain at each node, even when nodes receive transactions in different orderings. The blockchain 604 shown by FIG. 6 includes blocks such as block 604a, block 604b, and/or block 604c. Likewise, embodiments of the blockchain system 600 can include different and/or additional components or be connected in different ways.

The terms “blockchain” and “chain” are used interchangeably herein. In embodiments, the blockchain 604 is a distributed database that is shared among the nodes of a computer network. As a database, the blockchain 604 stores information electronically in a digital format. The blockchain 604 can maintain a secure and decentralized record of transactions (e.g., transactions such as transaction 624a and/or transaction 624b). For example, the ERC-721 or ERC-1155 standards are used for maintaining a secure and decentralized record of transactions. The blockchain 604 provides fidelity and security for the data record. In embodiments, blockchain 604 collects information together in groups, known as “blocks” (e.g., blocks such as block 604a, block 604b, and/or block 604c) that hold sets of information.

The blockchain 604 structures its data into chunks (blocks) (e.g., blocks such as block 604a, block 604b, and/or block 604c) that are strung together. Blocks (e.g., block 604c) have certain storage capacities and, when filled, are closed and linked to a previously filled block (e.g., block 604b), forming a chain of data known as the “blockchain.” New information that follows a freshly added block (e.g., block 604b) is compiled into a newly formed block (e.g., block 604c) that will then also be added to the blockchain 604 once filled. The data structure inherently makes an irreversible timeline of data when implemented in a decentralized nature. When a block is filled, it becomes a part of this timeline of blocks. Each block (e.g., block 604a) in the blockchain system 600 is given an exact timestamp (e.g., timestamp 612a) when it is added to the blockchain system 600. In the example of FIG. 6, blockchain system 600 includes multiple blocks. Each of the blocks (e.g., block 604a, block 604b, block 604c) can represent one or multiple transactions and can include a cryptographic hash of the previous block (e.g., previous hashes 608a-c), a timestamp (e.g., timestamps 612a-c), a transactions root hash (e.g., 616a-c), and a nonce (e.g., 620a-c). A transactions root hash (e.g., transactions root hash 616b) indicates the proof that the block 604b contains all the transactions in the proper order. Transactions root hash 616b proves the integrity of transactions in the block 604b without presenting all transactions.

In embodiments, the timestamp 612a-c of each of corresponding blocks of block 604a, block 604b, block 604c includes data indicating a time associated with the block. In some examples, the timestamp includes a sequence of characters that uniquely identifies a given point in time. In one example, the timestamp of a block includes the previous timestamp in its hash and enables the sequence of block generation to be verified.

In embodiments, nonces 620a-c of each of corresponding blocks of block 604a, block 604b, block 604c include any generated random or semi-random number. The nonce can be used by miners during proof of work (PoW), which refers to a form of adding new blocks of transactions to blockchain 604. The work refers to generating a hash that matches the target hash for the current block. For example, a nonce is an arbitrary number that miners (e.g., devices that validate blocks) can change in order to modify a header hash and produce a hash that is less than or equal to the target hash value set by the network.

As described above, each of blocks of block 604a, block 604b, block 604c of blockchain 604 can include respective block hash, e.g., transactions root hash 616a, transactions root hash 616b, and transactions root hash 616c. Each of block hashes 616a-c can represent a hash of a root node of a Merkle tree for the contents of the block (e.g., the transactions of the corresponding block). For example, the Merkle tree contains leaf nodes corresponding to hashes of components of the transaction, such as a reference that identifies an output of a prior transaction that is input to the transaction, an attachment, and a command. Each non-leaf node can contain a hash of the hashes of its child nodes. The Merkle tree can also be considered to have each component as the leaf node with its parent node corresponding to the hash of the component.

In the example of FIG. 6, block 604b records transactions 624a-d. Each of the leaf nodes 628a-d contain a hash corresponding to transactions 624a-d respectively. As described above, a hash (e.g., the hash in leaf node such as node 628a) can be a hash of components of a transaction (e.g., transaction 624a), for example, a reference that identifies an output of a prior transaction that is input to the transaction 624a, an attachment, and a command. Each of the non-leaf nodes of node 632a and node 632b can contain a hash of the hashes of its child nodes (e.g., leaf nodes such as node 628a and node 628b). In this example, node 632a can contain a hash of the hashes contained in node 628a, node 628b and node 632b can contain a hash of the hashes contained in node 628c, node 628d. The root node, which includes (e.g., contains) transactions root hash 616b, can contain a hash of the hashes of child nodes 632a-b.

A Merkle tree representation of a transaction (e.g., transaction 624a) allows an entity needing access to the transaction 624a to be provided with only a portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction 624a by generating a hash of the transaction summary and calculating the hashes of the nodes along the path to the root node. If the calculated hash of the root node matches the hash of node 628a of the transaction 624a, the transaction summary is confirmed as the one used in the transaction. Because only the portion of the Merkle tree relating to components that an entity needs is provided, the entity will not have access to other components. Thus, the confidentiality of the other components is not compromised.

To transfer ownership of a digital asset, such as a bitcoin, using the blockchain system 600, a new transaction, such as one of transactions 624a-d, is generated and added to a stack of transactions in a block, e.g., block 604b. To record a transaction in a blockchain, each party and asset involved with the transaction needs an account that is identified by a digital token. For example, when a first user wants to transfer an asset that the first user owns to a second user, the first and second user both create accounts, and the first user also creates an account that is uniquely identified by the asset's identification number. The account for the asset identifies the first user as being the current owner of the asset. The first user (i.e., the current owner) creates a transaction (e.g., transaction 624a) against the account for the asset that indicates that the transaction 624a is a transfer of ownership and outputs a token identifying the second user as the next owner and a token identifying the asset. The transaction 624a is signed by the private key of the first user (i.e., the current owner), and the transaction 624a is evidence that the second user is now the new current owner and that ownership has been transferred from the first to the second user.

The transaction 624a (e.g., a new transaction), which includes the public key of the new owner (e.g., a second user to whom a digital asset is assigned ownership in the transaction), is digitally signed by the first user with the first user's private key to transfer ownership to the second user (e.g., new owner), as represented by the second user public key. The signing by the owner of the bitcoin is an authorization by the owner to transfer ownership of the bitcoin to the new owner via the transaction 624a (e.g., the new transaction). Once the block is full, the block is “capped” with a block header, that is, a hash digest of all the transaction identifiers within the block. The block header is recorded as the first transaction in the next block in the chain, creating a mathematical hierarchy called the “blockchain.” To verify the current owner, the blockchain 604 of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

Additionally, in some embodiments, the blockchain system 600 uses one or more smart contracts to enable more complex transactions. A smart contract includes computer code implementing transactions of a contract. The computer code can be executed on a secure platform (e.g., an Ethereum platform, which provides a virtual machine) that supports recording transactions (e.g., 624a-d) in blockchains. For example, a smart contract can be a self-executing contract with the terms of the agreement between buyer and seller being directly written into lines of code. The code and the agreements contained therein exist across a distributed, decentralized blockchain network.

In addition, the smart contract can itself be recorded as a transaction 624a in the blockchain 604 using a token that is a hash of node 628a of the computer code so that the computer code that is executed can be authenticated. When deployed, a constructor of the smart contract executes, initializing the smart contract and its state. The state of a smart contract is stored persistently in the blockchain 604. When a transaction 624a is recorded against a smart contract, a message is sent to the smart contract, and the computer code of the smart contract executes to implement the transaction (e.g., debit a certain amount from the balance of an account). The computer code ensures that all the terms of the contract are complied with before the transaction 624a is recorded in the blockchain 604.

For example, a smart contract can support the sale of an asset. The inputs to a smart contract to sell an asset can be tokens identifying the seller, the buyer, the asset, and the sale price in U.S. dollars or cryptocurrency. The computer code is used to ensure that the seller is the current owner of the asset and that the buyer has sufficient funds in their account. The computer code records a transaction (e.g., transaction 624a) that transfers the ownership of the asset to the buyer and a transaction (e.g., transaction 624b) that transfers the sale price from the buyer's account to the seller's account. If the seller's account is in U.S. dollars and the buyer's account is in Canadian dollars, the computer code can retrieve a currency exchange rate, determine how many Canadian dollars the seller's account should be debited, and record the exchange rate. If either of transaction 624a or transaction 624b is not successful, neither transaction is recorded.

When a message is sent to a smart contract to record a transaction 624a, the message is sent to each node that maintains a replica of the blockchain 604. Each node executes the computer code of the smart contract to implement the transaction 624a. For example, if a hundred nodes each maintain a replica of the blockchain 604, the computer code executes at each of the hundred nodes. When a node completes execution of the computer code, the result of the transaction 624a is recorded in the blockchain 604. The nodes employ a consensus algorithm to decide which transactions (e.g., transaction 624c) to keep and which transactions (e.g., transaction 624d) to discard. Although the execution of the computer code at each node helps ensure the authenticity of the blockchain 604, large amounts of computer resources are required to support such redundant execution of computer code.

Although blockchains can effectively store transactions 624a-d, the large amount of computer resources, such as storage and computational power, needed to maintain all the replicas of the blockchain can be problematic. To overcome this problem, some systems for storing transactions 624a-d do not use blockchains, but rather have each party to a transaction maintain its own copy of the transaction 624a. One such system is the Corda™ system developed by R3™ that provides a decentralized distributed ledger platform in which each participant in the platform has a node (e.g., computer system) that maintains its portion of the distributed ledger.

When parties agree on the terms of a transaction 624a, a party submits the transaction 624a to a notary, which is a trusted node, for notarization. The notary maintains a consumed output database of transaction outputs that have been input into other transactions. When a transaction 624a is received, the notary checks the inputs to the transaction 624a against the consumed output database to ensure that the outputs that the inputs reference have not been spent. If the inputs have not been spent, the notary updates the consumed output database to indicate that the referenced outputs have been spent, notarizes the transaction 624a (e.g., by signing the transaction or a transaction identifier with a private key of the notary), and sends the notarized transaction to the party that submitted the transaction 624a for notarization. When the party receives the notarized transaction, the party stores the notarized transaction and provides the notarized transaction to the counterparties.

In embodiments, a notary is a non-validating notary or a validating notary. When a non-validating notary is to notarize a transaction (e.g., transaction 624b), the non-validating notary determines that the prior output of a prior transaction (e.g., transaction 624a), that is, the input of a current transaction, e.g., transaction 624b, has not been consumed. If the prior output has not been consumed, the non-validating notary notarizes the transaction 624b by signing a hash of node 628b of the transaction. To notarize a transaction 624b, a non-validating notary needs only the identification of the prior output (e.g., the hash of node 628a of the prior transaction (e.g., transaction 624a) and the index of the output) and the portion of the Merkle tree needed to calculate the hash of node 628b of the transaction 624b.

As described herein, in some embodiments, the blockchain system 600 uses one or more smart contracts to enable more complex transactions. For example, a validating notary validates a transaction (e.g., transaction 624d), which includes verifying that prior transactions 624a-c in a backchain of transactions are valid. The backchain refers to the collection of prior transactions (e.g., transaction 624c) of a transaction 624d, as well as prior transactions of transaction 624a, transaction 624b, and transaction 624c, and so on. To validate a transaction 624d, a validating notary invokes validation code of the transaction 624d. In one example, a validating notary invokes validation code of a smart contract of the transaction 624d. The validation code performs whatever checks are needed to comply with the terms applicable to the transaction 624d. This checking can include retrieving the public key of the owner from the prior transaction (e.g., transaction 624c) (pointed to by the input state of the transaction 624d) and checks the signature of the transaction 624d, ensuring that the prior output of a prior transaction that is input has not been consumed, and checking the validity of each transaction (e.g., transaction 624c) in the backchain of the transactions. If the validation code indicates that the transaction 624d is valid, the validating notary notarizes the transaction 624d and records the output of the prior transaction (e.g., transaction 624c) as consumed.

In some examples, to verify that the transactions 624a-d in a ledger stored at a node are correct, the blocks, e.g., block 604a, block 604b, block 604c in the blockchain 604 can be accessed from oldest block (e.g., block 604a) to newest block (e.g., block 604c), generating a new hash of the block 604c and comparing the new hash to the hash 608c generated when the block 604c was created. If the hashes are the same, then the transactions in the block are verified. In one example, the Bitcoin system also implements techniques to ensure that it would be infeasible to change a transaction 624a and regenerate the blockchain 604 by employing a computationally expensive technique to generate a nonce 620b that is added to the block when it is created. A bitcoin ledger is sometimes referred to as an Unspent Transaction Output (“UTXO”) set because it tracks the output of all transactions that have not yet been spent.

In some embodiments, a self-sovereign identity (SSI) approach to digital identity is used that gives individuals control over the information they use to prove who they are to websites, services, and applications across the web. For example, the user device 110, mobile application 120, or remote server 130 uses an SSI protocol or SSI technology to enable a user to access data or present credentials to log in. In an SSI system, the user accesses services in a streamlined and secure manner, while maintaining control over the information associated with their identity. SSI addresses the difficulty of establishing trust in an interaction. In order to be trusted, one party in an interaction will present credentials to the other parties, and those relying on parties can verify that the credentials came from an issuer that they trust. In this way, the verifier's trust in the issuer is transferred to the credential holder. This basic structure of SSI with three participants is sometimes called “the trust triangle”. For an identity system to be self-sovereign, users control the verifiable credentials that they hold and their consent is required to use those credentials. This reduces the unintended sharing of users' personal data.

In an SSI system, holders generate and control unique identifiers called decentralized identifiers. Most SSI systems are decentralized, where the credentials are managed using crypto wallets and verified using public-key cryptography anchored on a distributed ledger. The credentials may contain data from an issuer's database, a social media account, a history of transactions on an e-commerce site, or attestation from friends or colleagues.

FIG. 7 is a block diagram illustrating an example machine learning (ML) system 700, in accordance with one or more embodiments of this disclosure. The ML system 700 is implemented using components of the example computer system 800 illustrated and described in more detail with reference to FIG. 8. For example, the ML system 700 can be implemented on the processor 802 using instructions 808 programmed in the memory 806 illustrated and described in more detail with reference to FIG. 8. Likewise, implementations of the ML system 700 can include different and/or additional components or be connected in different ways. The ML system 700 is sometimes referred to as a ML module.

The ML system 700 includes a feature extraction module 708 implemented using components of the example computer system 800 illustrated and described in more detail with reference to FIG. 8. In some implementations, the feature extraction module 708 extracts a feature vector 712 from input data 704. For example, the input data 704 can be user information and astrocartographical information described in more detail with reference to FIGS. 1-4. The feature vector 712 includes features 712a, 712b, . . . , 712n. For example, the feature extraction module 708 extracts a feature vector from the user information and astrocartographical information.

The feature extraction module 708 reduces the redundancy in the input data 704, e.g., repetitive data values, to transform the input data 704 into the reduced set of features, e.g., features 712a, 712b, . . . , 712n. The feature vector 712 contains the relevant information from the input data 704, such that events or data value thresholds of interest can be identified by the ML model 716 by using this reduced representation. In some example implementations, the following dimensionality reduction techniques are used by the feature extraction module 708: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate implementations, the ML model 716 performs deep learning (also known as deep structured learning or hierarchical learning) directly on the input data 704 to learn data representations, as opposed to using task-specific algorithms. In deep learning, no explicit feature extraction is performed; the features 712a, 712b, . . . , 712n are implicitly extracted by the ML system 700. For example, the ML model 716 can use a cascade of multiple layers of nonlinear processing units for implicit feature extraction and transformation. Each successive layer uses the output from the previous layer as input. The ML model 716 can thus learn in supervised (e.g., classification) and/or unsupervised (e.g., pattern analysis) modes. The ML model 716 can learn multiple levels of representations that correspond to different levels of abstraction, wherein the different levels form a hierarchy of concepts. In this manner, the ML model 716 can be configured to differentiate features of interest from background features.

The output 724 is provided to the computer device 728 or the computer server 130 described in more detail with reference to FIG. 1. The computer device 728 is a server, computer, tablet, smartphone, smart speaker, etc., implemented using components of the example computer system 800 illustrated and described in more detail with reference to FIG. 8. In some implementations, the steps performed by the ML system 700 are stored in memory on the computer device 728 for execution. In other implementations, the output 724 is displayed on the display device 818 illustrated and described in more detail with reference to FIG. 8.

In alternative example implementations, the ML model 716, e.g., in the form of a CNN generates the output 724, without the need for feature extraction, directly from the input data 704. For example, the output 724 is an organizational name extracted from an identification document. The ML model 716 can be a CNN that includes both convolutional layers and max pooling layers. A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing. The architecture of the ML model 716 can be “fully convolutional,” which means that variable-sized test location data vectors can be fed into it. For all convolutional layers, the ML model 716 can specify a kernel size, a stride of the convolution, and an amount of zero padding applied to the input of that layer. For the pooling layers, the ML model 716 can specify the kernel size and stride of the pooling.

In some implementations, the ML system 700 trains the ML model 716, based on the training data 720, to correlate the feature vector 712 to expected outputs in the training data 720. For example, the ML model 716 is trained to determine suggestions for a user based on their user input and astrocartographical data. As part of the training of the ML model 716, the ML system 700 forms a training set of features and training labels by identifying a positive training set of features that have been determined to have a desired property in question, and, in some implementations, forms a negative training set of features that lack the property in question.

The ML system 700 applies ML techniques to train the ML model 716, that when applied to the feature vector 712, outputs indications of whether the feature vector 712 has an associated desired property or properties, such as a probability that the feature vector 712 has a particular Boolean property, or an estimated value of a scalar property. The ML system 700 can further apply dimensionality reduction (e.g., via linear discriminant analysis (LDA), PCA, or the like) to reduce the amount of data in the feature vector 712 to a smaller, more representative set of data.

The ML system 700 can use supervised ML to train the ML model 716, with feature vectors of the positive training set and the negative training set serving as the inputs. In some implementations, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example implementations, a validation set 732 is formed of additional features, other than those in the training data 720, which have already been determined to have or to lack the property in question. The ML system 700 applies the trained ML model 716 to the features of the validation set 732 to quantify the accuracy of the ML model 716. Common metrics applied in accuracy measurement include: Precision and Recall, where Precision refers to a number of results the ML model 716 correctly predicted out of the total it predicted, and Recall is a number of results the ML model 716 correctly predicted out of the total number of features that had the desired property in question. In some implementations, the ML system 700 iteratively re-trains the ML model 716 until the occurrence of a stopping condition, such as the accuracy measurement indication that the ML model 716 is sufficiently accurate, or a number of training rounds having taken place. The validation set 732 can include determined suggestions based on known astrocartographical data. This allows the detected values to be validated using the validation set 732. The validation set 732 can be generated based on analysis to be performed.

In some embodiments, ML system 700 is a generative artificial intelligence or generative AI system capable of generating text, images, or other media in response to prompts. Generative AI systems use generative models such as large language models to produce data based on the training data set that was used to create them. A generative AI system is constructed by applying unsupervised or self-supervised machine learning to a data set. The capabilities of a generative AI system depend on the modality or type of the data set used. For example, generative AI systems trained on words or word tokens are capable of natural language processing, machine translation, and natural language generation and can be used as foundation models for other tasks. In addition to natural language text, large language models can be trained on programming language text, allowing them to generate source code for new computer programs. Generative AI systems trained on sets of images with text captions are used for text-to-image generation and neural style transfer.

FIG. 8 is a block diagram illustrating an example computer system 800, in accordance with one or more embodiments of this disclosure. As shown, the computer system 800 can include: one or more processors 802, main memory 806, non-volatile memory 810, a network interface device 812, video display device 818, an input/output device 820, a control device 822 (e.g., keyboard and pointing device), a drive unit 824 that includes a storage medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 800. In some implementation, the computer system 800 can be an embedded computer system, a system-on-chip (SOC), a single-board computer system (SBC) or a distributed system such as a mesh of computer systems or include one or more cloud components in one or more networks. Where appropriate, one or more computer systems 800 can perform operations in real-time, near real-time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 600 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following examples should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the examples. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

I claim:

1. A computer-implemented method for generating a graphical user interface, comprising:
causing a user device to display a graphical user interface on an electronic screen of the user device,
wherein the graphical user interface comprises multiple fields for inputting a birth date, a birth time, and a birth location using a first application programming interface (API);
receiving, via the multiple fields, first information comprising the birth date, the birth time, and the birth location for a user using the first API;
retrieving, from a remote computer system, second information comprising multiple first celestial body positions stored on the remote computer system using a second API;
determining a first celestial body position from the multiple first celestial body positions corresponding to the first information,
wherein the first celestial body position comprises at least a position of a first celestial body relative to Earth at the birth date, the birth time, and the birth location;
generating a first three-dimensional trajectory ring corresponding to a rising and setting boundary of the first celestial body;
generating a first three-dimensional meridian ring corresponding to the first celestial body position;
determining two intersections between the first trajectory ring and the first meridian ring;
projecting the first trajectory ring and the first meridian ring onto a two-dimensional surface representative of a surface of the Earth; and
producing, on the graphical user interface, a visual representation comprising:
the two-dimensional surface representative of the surface of the Earth,
a first graphical symbol representative of the birth location of the user on the two-dimensional surface,
a first vertical line on the two-dimensional surface representative of a first section of the first meridian ring,
wherein the first section of the first meridian ring is determined by the two intersections,
a second vertical line on the two-dimensional surface representative of a second section of the first meridian ring,
wherein the second section of the first meridian ring is determined by the two intersections,
a second graphical symbol representative of the first celestial body position,
wherein the second graphical symbol is positioned on the first vertical line, and
a first curved line representative of the first trajectory ring on the two-dimensional surface.

2. The method of claim 1, wherein the second information further comprises multiple second celestial body positions, the method further comprising:
determining a second celestial body position from the multiple second celestial body positions corresponding to the first information, wherein the second celestial body position comprises at least a position of a second celestial body relative to Earth at the birth date, the birth time, and the birth location;
generating a second three-dimensional trajectory ring corresponding to a rising and setting boundary of the second celestial body;
generating a second three-dimensional meridian ring corresponding to the second celestial body position;
determining two intersections between the second trajectory ring and the second meridian ring;
projecting the second trajectory ring and the second meridian ring onto the two-dimensional surface representative of the surface of the Earth; and
producing, on the graphical user interface:
a third vertical line on the two-dimensional surface representative of a first section of the second meridian ring, wherein the first section of the second meridian ring is determined by the two intersections,
a fourth vertical line on the two-dimensional surface representative of a second section of the second meridian ring, wherein the second section of the second meridian ring is determined by the two intersections between the second trajectory ring and the second meridian ring,
a third graphical symbol representative of the second celestial body position, wherein the third graphical symbol is positioned on the third vertical line, and
a second curved line representative of the second trajectory ring on the two-dimensional surface.

3. The method of claim 1, further comprising:
retrieving, from the remote computer system, third information comprising one or more aspects related to celestial bodies stored on the remote computer system using the second API; and
producing, on the graphical user interface, third graphical symbols representative of the third information.

4. The method of claim 3, wherein the third information comprises labels of the celestial bodies.

5. The method of claim 3, wherein the third information comprises one or more suggestions for the user at geographical locations.

6. The method of claim 3, further comprising:
receiving, from the user, one or more filter parameters;
filtering the third information based on the one or more filter parameters; and
producing, on the graphical user interface, fourth graphical symbols representative of the filtered third information.

7. The method of claim 1, further comprising:
receiving, from the user, a selection of one of the first vertical line, the second vertical line, or the first curved line; and
producing, on the graphical user interface, an area of influence of the selection.

8. The method of claim 7, wherein the area of influence is based on a predetermined geographical distance extending from the selection.

9. The method of claim 1, further comprising:
retrieving social media information from one or more social media feeds;
using a machine learning algorithm to extract aspects related to the first celestial body from the social media information; and
producing, on the graphical user interface, the aspects.

10. The method of claim 1, further comprising:
receiving, from the user at the graphical user interface, a request; and
producing, on the graphical user interface, third information generated by one or more generative machine learning models,
wherein the third information is generated by the one or more generative machine learning models in response to the request and based on the first information and the second information,
wherein the one or more generative machine learning models are trained to generate, in response to input training data including the first information, the second information, exemplary requests, and exemplary third information, a corresponding output of the third information, and
wherein the output of the third information comprises a newly generated portion of content that shares one or more properties with the input training data and thereby extends the input training data.

11. At least one non-transitory computer-readable storage medium storing instructions to generate a graphical user interface, wherein the instructions, when executed by at least one data processor of a system, cause the system to perform a method of:
causing a user device to display a graphical user interface on an electronic screen of the user device,
wherein the graphical user interface comprises multiple fields for inputting a birth date, a birth time, and a birth location using a first application programming interface (API);
receiving, via the multiple fields, first information comprising the birth date, the birth time, and the birth location for a user using the first API;
retrieving, from a remote computer system, second information comprising multiple first celestial body positions stored on the remote computer system using a second API;
determining a first celestial body position from the multiple first celestial body positions corresponding to the first information, wherein the first celestial body position comprises at least a position of a first celestial body relative to Earth at the birth date, the birth time, and the birth location;
generating a first three-dimensional trajectory ring corresponding to a rising and setting boundary of the first celestial body;
generating a first three-dimensional meridian ring corresponding to the first celestial body position;
determining two intersections between the first trajectory ring and the first meridian ring;
projecting the first trajectory ring and the first meridian ring onto a two-dimensional surface representative of a surface of the Earth; and
producing, on the graphical user interface, a visual representation comprising:
the two-dimensional surface representative of the surface of the Earth,
a first graphical symbol representative of the birth location of the user on the two-dimensional surface,
a first vertical line on the two-dimensional surface representative of a first section of the first meridian ring, wherein the first section of the first meridian ring is determined by the two intersections,
a second vertical line on the two-dimensional surface representative of a second section of the first meridian ring, wherein the second section of the first meridian ring is determined by the two intersections,
a second graphical symbol representative of the first celestial body position, wherein the second graphical symbol is positioned on the first vertical line, and
a first curved line representative of the first trajectory ring on the two-dimensional surface.

12. The computer-readable storage medium of claim 11, wherein the second information further comprises multiple second celestial body positions, wherein the method further comprises:
determining a second celestial body position from the multiple second celestial body positions corresponding to the first information, wherein the second celestial body position comprises at least a position of a second celestial body relative to Earth at the birth date, the birth time, and the birth location;
generating a second three-dimensional trajectory ring corresponding to a rising and setting boundary of the second celestial body;
generating a second three-dimensional meridian ring corresponding to the second celestial body position;
determining two intersections between the second trajectory ring and the second meridian ring;
projecting the second trajectory ring and the second meridian ring onto the two-dimensional surface representative of the surface of the Earth; and
producing, on the graphical user interface:
a third vertical line on the two-dimensional surface representative of a first section of the second meridian ring, wherein the first section of the second meridian ring is determined by the two intersections,
a fourth vertical line on the two-dimensional surface representative of a second section of the second meridian ring, wherein the second section of the second meridian ring is determined by the two intersections between the second trajectory ring and the second meridian ring,
a third graphical symbol representative of the second celestial body position, wherein the third graphical symbol is positioned on the third vertical line, and
a second curved line representative of the second trajectory ring on the two-dimensional surface.

13. The computer-readable storage medium of claim 11, wherein the method further comprises:
retrieving, from the remote computer system, third information comprising one or more aspects related to celestial bodies stored on the remote computer system using the second API; and
producing, on the graphical user interface, third graphical symbols representative of the third information.

14. The computer-readable storage medium of claim 13, wherein the third information comprises labels of the celestial bodies.

15. The computer-readable storage medium of claim 13, wherein the third information comprises one or more suggestions for the user at geographical locations.

16. The computer-readable storage medium of claim 13, wherein the method further comprises:
receiving, from the user, one or more filter parameters;
filtering the third information based on the one or more filter parameters; and
producing, on the graphical user interface, fourth graphical symbols representative of the filtered third information.

17. The computer-readable storage medium of claim 11, wherein the method further comprises:
receiving, from the user, a selection of one of the first vertical line, the second vertical line, or the first curved line; and
producing, on the graphical user interface, an area of influence of the selection.

18. The computer-readable storage medium of claim 17, wherein the area of influence is based on a predetermined geographical distance extending from the selection.

19. The computer-readable storage medium of claim 11, wherein the method further comprises:
receiving, from the user at the graphical user interface, a request; and
producing, on the graphical user interface, third information generated by one or more generative machine learning models,
wherein the third information is generated by the one or more generative machine learning models in response to the request and based on the first information and the second information,
wherein the one or more generative machine learning models are trained to generate, in response to input training data including the first information, the second information, exemplary requests, and exemplary third information, a corresponding output of the third information, and
wherein the output of the third information comprises a newly generated portion of content that shares one or more properties with the input training data and thereby extends the input training data.

20. A system for generating a graphical user interface, comprising:
a hardware processor; and
a non-transitory memory storing instructions, which, when executed by the hardware processor, cause the system to perform a method of:
causing a user device to display a graphical user interface on an electronic screen of the user device,
wherein the graphical user interface comprises multiple fields for inputting a birth date, a birth time, and a birth location using a first application programming interface (API);
receiving, via the multiple fields, first information comprising the birth date, the birth time, and the birth location for a user using the first API;
retrieving, from a remote computer system, second information comprising multiple first celestial body positions stored on the remote computer system using a second API;
determining a first celestial body position from the multiple first celestial body positions corresponding to the first information, wherein the first celestial body position comprises at least a position of a first celestial body relative to Earth at the birth date, the birth time, and the birth location;
generating a first three-dimensional trajectory ring corresponding to a rising and setting boundary of the first celestial body;
generating a first three-dimensional meridian ring corresponding to the first celestial body position;
determining two intersections between the first trajectory ring and the first meridian ring;
projecting the first trajectory ring and the first meridian ring onto a two-dimensional surface representative of a surface of the Earth; and
producing, on the graphical user interface, a visual representation comprising:
the two-dimensional surface representative of the surface of the Earth,
a first graphical symbol representative of the birth location of the user on the two-dimensional surface,
a first vertical line on the two-dimensional surface representative of a first section of the first meridian ring, wherein the first section of the first meridian ring is determined by the two intersections,
a second vertical line on the two-dimensional surface representative of a second section of the first meridian ring, wherein the second section of the first meridian ring is determined by the two intersections,
a second graphical symbol representative of the first celestial body position, wherein the second graphical symbol is positioned on the first vertical line, and
a first curved line representative of the first trajectory ring on the two-dimensional surface.
